(19) United States
(12) Patent Application Publication
(10) Pub. No.: US 2017/0089101 A1
(43) Pub. Date: Mar. 30, 2017

(54) MOTOR VEHICLE DOOR LOCK WITH CHILD LOCK

(71) Applicant: Kiekert AG, Heiligenhaus (DE)

(72) Inventor: Thorsten Bendel, Oberhausen (DE)

(21) Appl. No.: 15/301,725

(22) PCT Filed: Mar. 9, 2015
(86) PCT No.: PCT/DE2015/100092

§ 371 Date: Oct. 4, 2016

(30) Foreign Application Priority Data
Mar. 14, 2014 (DE) 10 2014 003 505.0

(51) Int. Cl. E05B 77/26; E05B 41/00; E05B 17/10

(52) U.S. Cl. CPC E05B 77/26; E05B 17/10; E05B 41/00

(57) ABSTRACT

The locked or unlocked position of a child lock (6) even in the dark, can be easily recognized when the actuation head (8) of the child lock (6) is provided with a switch identification light (15). Said switch identification light (15) comprises light-emitting diodes (16, 17) which illuminate the entire area around the child lock (6) such that even in unfavourable lighting conditions, the important component of the motor vehicle door (1) can be actuated safely and the switching position can be identified.

The invention relates to a motor vehicle door latch with a latch housed in a latch housing in the motor vehicle door with an internal activation lever and an assigned child safety, which can be activated when the motor vehicle door is open, with a child safety lever or an activation shaft and activation button which must be handled from the front of the motor vehicle door or the driver's door and have the safety catch for the internal activation lever at the free end.

Child safeties in motor vehicles are described as locking devices which prevent opening of the rear motor vehicle doors from the inside. Generally, the child safety consists of a small switch on the edge of the door or on the front of the motor vehicle door which cannot be activated when the motor vehicle door is closed. If this small switch has been activated, the motor vehicle door can only be opened from the outside. Child safeties in the motor vehicle are also known which are connected to the rear electrical window lifting mechanism. A general execution of the motor vehicle door with a child safety can be found in DE 88 09 256.9 GM. In this known child safety, the activation button must be activated with a kind of key from the front of the motor vehicle door. Consequently, the safety catch located at the free end can be pushed onto the internal activation lever. Consequently, the motor vehicle door can then no longer be opened from the inside. However, the driver or other adult can only detect the position assumed by the child safety by opening the rear motor vehicle door. However, in the case of unfavorable light conditions, for example at night or in a garage, the respective position of the child safety cannot be detected readily.

The invention is therefore based on the task of creating a motor vehicle latch with a child safety, the changing switching state of which is easily and safely recognizable for the driver or the adult, even in unfavorable light conditions.

According to the invention, the task is solved by the child safety demonstrating a switch identification light integrated into the latch, via which the securing position and/or the free position can be displayed by means of lighting.

With such an execution of a child safety, the driver of the motor vehicle or also another adult or the child himself can easily detect whether the child safety is activated or not. It is advantageous that the switch identification light is conveniently affixed close to the actual child safety on the front side of the motor vehicle door. Consequently, the person activating the safety catch can immediately recognize, even when activating, whether the child safety is switched on or not. At the same time, activation verification is possible even under unfavorable light conditions. Consequently, a significant increase in the operational safety of such a motor vehicle overall can be attained with the solution according to the invention.

According to an expedient execution of the invention, it is provided for that the switch identification light is designed as a light diode and is integrated into the infeed section of the catch of the latch. The infeed section of the catch of the latch is generally provided about halfway up the motor vehicle door. Consequently, this position ensures easy and safe recognition of the position of the child safety. By the integration or arrangement of the switch identification light in the area of the infeed section, time-consuming work necessary in addition to the integration or placement of the child safety, such as for cables and similar, is no longer required because the inside of the motor vehicle door is easily accessible from there, where the cables still required are laid or can be laid.

An advantage results from the arrangement of the light source or the switch identification light, directly in the lateral door latch, namely that a power supply is already present in the latch. Costly integration into the lateral door is not necessary. The switch identification light can be a direct component of the lateral door latch. A further advantage according to the invention results from this. The switching device for activation or deactivation can also be present in the lateral door latch. This is especially easy to execute as only one position of the child safety needs to be requested or detected. The activation button itself can also include the switching device.

The light diode or also two or several light diodes are characterized by low energy consumption. Furthermore, it is advantageous that such high-performance LEDs can be arranged according to a selectable diagram and can thus be positioned according to the expediency with a certain statement. In the present case, it should be displayed whether the child safety is switched on or not. It is thus expedient to arrange the high-performance LEDs, for example, in a punctiform manner or resulting in a point.

A further expedient design provides for the switch identification light or the latch being generally assigned to a light sensor and connected to the switch identification light by means of a circuit. In the presence of such a sensor, the color can be expediently used, for example in red and green for secured or unsecured, whereby there is naturally also the possibility of using correspondingly colored LEDs.

The light diodes should be expediently assigned to the activation button, whereby there is then the possibility of assigning an attachable cover consisting of a translucent material to the activation button in or on which the light diodes are distributed to secure the light diodes. This simultaneously has the advantage that the activation slot in the activation button is easier to reach because this activation slot is then also formed in the cover and, if applicable, can even be equipped with conducting lateral bars.

Further above, it was pointed out that the light diodes are expediently arranged in such a way that they form a point together. According to a further expedient design, it is possible for the light diodes to be arranged in such a way that they form a circle around the switching component on the activation button. This special arrangement also assists the operator when he wants to activate the activation button because he can now also accurately detect in darkness where he needs to insert the key or the activation device into the activation slot in order to safely shift the activation button into the next and desired position.

Further above, it was pointed out that the activation button is expediently positioned in the area of the infeed section or in the infeed section. In order to prevent damage to or impairment of the activation button here, it is envisaged that the activation button of the child safety is engaged into the wall of the infeed section. Thus, protrusions are avoided and even if the motor vehicle door is closed and the latch bracket passes the infeed section, no damage can occur to the activation button and thus the child safety.

If no sensor is present or if it is dispensed with and if switching of the light diodes is not desired, it is advantageous if the light diodes are arranged to form a green-colored circle and a red-colored second circle and are separately addressable from a supply perspective. Thus, either the green-colored circle or the red-colored second circle can be addressed by means of a circuit if the activation button is shifted or rotated into the relevant position.

As mentioned above, the switch identification light or its light diodes can also generally also be used to illuminate the child safety. It is advantageous if the light diodes can be switched over to white light, i.e. if the child safety is not at all activated as such. Thus, the latch area with the child safety is illuminated and also other parts of the latch, i.e. the emergency locking, for example.

Either in addition to the electrical supply or also in isolation, there is the option of forming the switch identification light with self-illuminating elements or elements reflecting extraneous light, because then the motor vehicle door latch or the child safety can be illuminated even without external power in such a way that it can easily be detected, even in darkness, in which switching position the child safety is located.

Naturally, there is also the possibility of illuminating the child safety lever, where it is visible. To this end, it is provided for that the switch identification light covers the free section of a child safety lever. Here, too, a power supply can easily be ensured. Consequently, even if, for example, an activation plug or a suitable switch is not present, the position this component has just assumed can be ascertained on the basis of the actual child safety lever.

It is generally sufficient if the child safety is supplied separately there from a lighting perspective, where it is housed in the motor vehicle door, i.e. the rear motor vehicle door. However, it can be expedient for the driver as such to detect the position in which the child safety is located when driving. This is possible when the switch identification light is connected with a display on the driver's door, the dashboard and/or the rear motor vehicle door from a circuitry and a lighting perspective. It is therefore displayed at various points inside the motor vehicle whether the child safety is activated or not. Consequently, if necessary, the driver can react with sufficient speed and can stop his vehicle to activate the child safety.

The invention is characterized by the possibility of optimizing the known child safety by it being able to be either activated or verified if necessary even in unfavorable lighting conditions. Consequently, optimum safety is guaranteed for this important component in the motor vehicle. The switch identification light assigned to the child safety illuminates the activation button assigned to the activation shaft, for example. Consequently, its position can be accurately verified, even in unfavorable lighting conditions with simultaneous improvement of handling. As a result of the switch identification light, the activation slot area on the activation button is easily visible and the activator can safely insert the switching element and also remove it again without requiring special lighting or a lamp. There is thus an increase in activation safety but also convenience. Consequently, this important component can now have an optimized effect.

Further details and advantages of the invention object result from the following description of the accompanying drawings in which a preferred execution example is depicted with the necessary details and individual components. The following are shown:

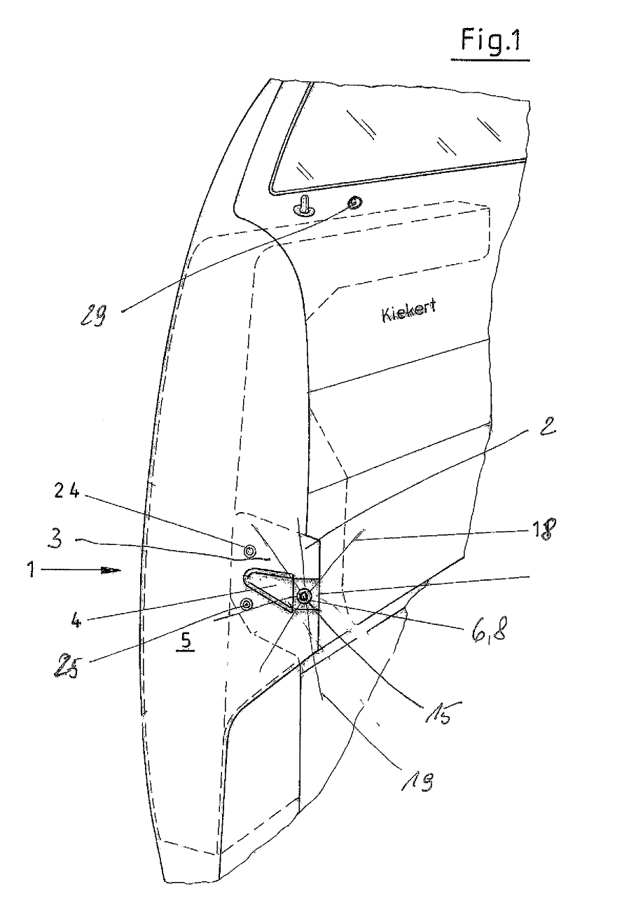

FIG. 1 an open motor vehicle door, namely a rear motor vehicle door,

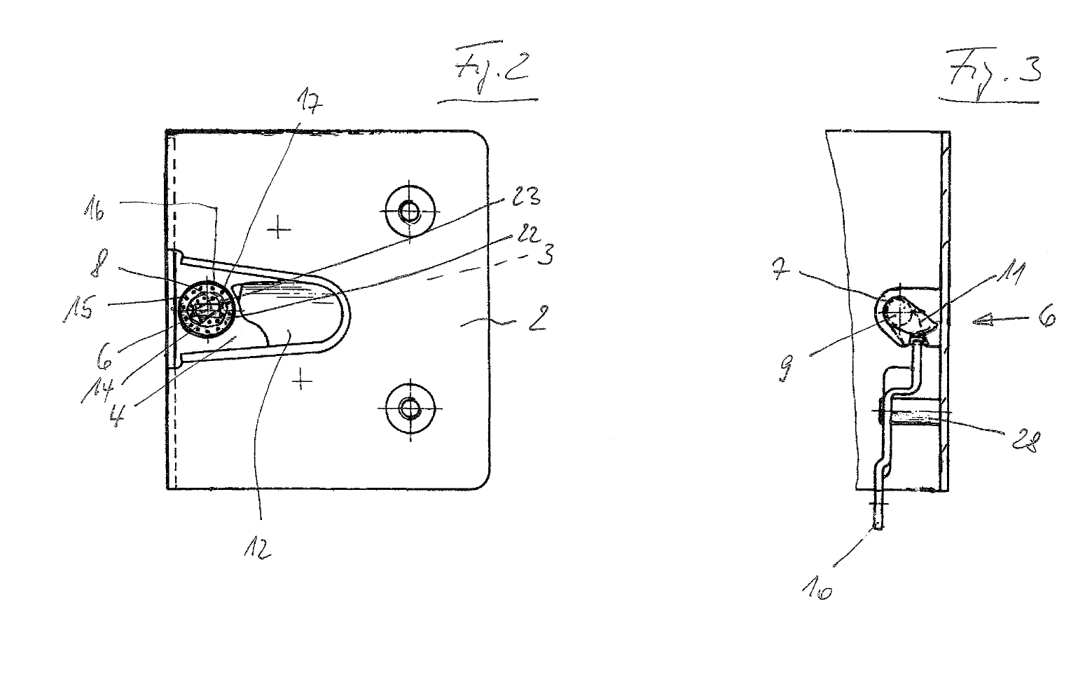

FIG. 2 a top view of a latch of a motor vehicle door with infeed section,

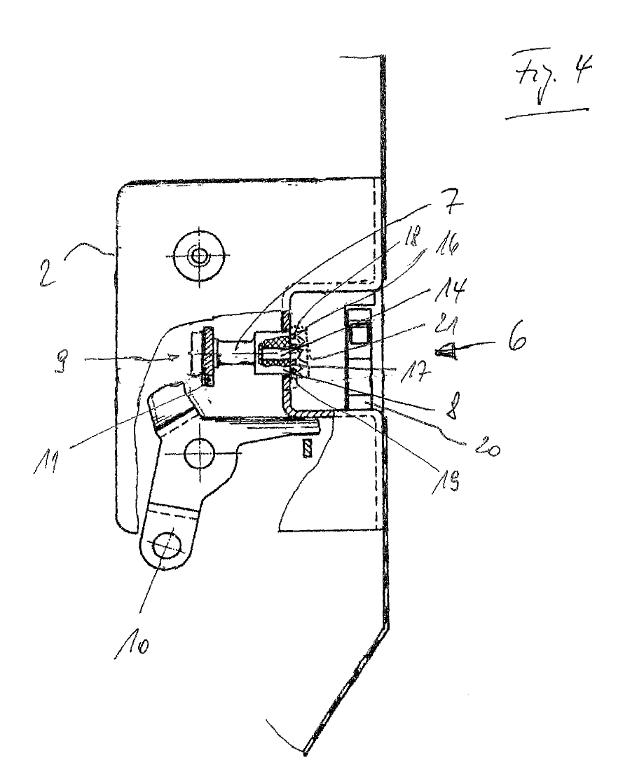

FIG. 3 a section with a view of the eccentric safety catch and the internal activation lever and

FIG. 4 a lateral view of the child safety with activation shaft and activation button.

In FIG. 1 a motor vehicle door 1 is shown, namely in the open state, wherein it is the rear motor vehicle door 1. The latch housing 2, which is integrated into this motor vehicle door 1 and incorporates a latch 3 is recognizable. From this, only the area of the infeed section 4 is visible, from which it is also clear that it involves the front side 5 of the motor vehicle door 1. A child safety 6 is integrated into this latch housing 2 or the latch 3, of which, however, only the switch identification light 15 is recognizable which is assigned here to the activation button 8 of the child safety 6.

24 and 25 describe the retaining screws with which the latch housing 2 is affixed in the motor vehicle door 1. 18 and 19 describe the rays of light of the switch identification light via which it is made clear that the switch position of the child safety 6 can be made easily visible via this switch identification light 15. The respective switch position is also identified by a display 29 here in the upper area of the motor vehicle door 1 which is only provided for in addition. The switch identification light 15 in the area of the infeed section 4 of the latch 3 is important, because the infeed section, which is explained again below, allows it to be easily recognized in unfavorable lighting conditions which switching position the child safety 6 is currently located in.

FIG. 2 shows the enlarged area of the infeed section 4, whereby it is recognizable that the child safety 6 or its activation button 8 is integrated into the wall 12 of the infeed section 4 or is housed in such a way there that damage from other components of the latch 3 does not need to be feared. The switch identification light 15 is housed on the activation button—recognizable here. This switch identification light 15 consists of a whole set of light-emitting diodes 16, 17 which are arranged here to form a first circle 22 and a second circle 23 on the activation button 8. One circle 22 is addressed when the child safety 6 is in the active position and in a green color, for example, while the second circle 23 which is addressed when the child safety 6 is inactive illustrates with its red color that the child safety 6 is not activated.

It is somewhat less easy to recognize that the activation slot 14 is arranged in the center of the activation button 8, which the activation element needs to be inserted into in order to pivot the child safety 6 for example from the inactive to the active position or vice versa.

FIG. 3 shows the other end of the child safety 6 namely the safety catch component 11 arranged on the activation shaft 7 at its free end 9 which has the form of an eccentric. It is recognizable that the internal activation lever 10 can be blocked via this eccentric or the safety catch 11. The internal activation lever 10 is moved around the pivoting axis 28 if the motor vehicle door 1 should be opened from the inside of the motor vehicle door 1. If the child safety 6 or its safety catch 11 is activated, i.e. rotated in such a way that the eccentric 11 rests on the end of the internal activation lever 10, the internal activation lever 10 is effectively blocked and the motor vehicle door 1 can only be opened from the outside.

From FIG. 4, it can be recognized that the child safety 6 in the depicted execution form consists of the activation shaft 7 and the activation button 8, whereby the free end 9 of the activation shaft 7 has the aforementioned eccentric or the safety catch 11.

A set of light diodes 16, 17 are arranged on the activation button 8 which are also clearly recognizable again by the light rays 18, 19 shown here. The activation button 8 itself is secured via a cover 21 so that components of the latch 3 sliding by cannot cause damage here.

The activator can always easily recognize the activation slot 14 in the activation button 8 even in unfavorable light conditions by the light diodes 16, 17 arranged in a circular shape. Consequently, it can be safely reached and activated with the switching component not depicted here. With rotation of the activation button 8 via the non-depicted switching component, the child safety can be easily and safely activated as mentioned even in poor light conditions, whereby its position can also be additionally identified by the display 29 and displays arranged further inside the motor vehicle.

All stated characteristics, including those which can be found only in the drawings, are viewed jointly and singularly as crucial to the invention.

1. A motor vehicle door latch with a latch housed in the motor vehicle door in a latch housing with an internal activation lever and an assigned child safety, which can be activated when the motor vehicle door is open, with a child safety lever or activation shaft and activation button, which must be handled from the front side of the motor vehicle door or the driver's door and have the safety catch for the internal activation lever at the free end, wherein the child safety has a switch identification light integrated into the latch, via which the safety catch position and/or also if necessary the release can be displayed by means of lighting.

2. The motor vehicle door latch according to claim 1, wherein the switch identification light is designed as a light diode and is integrated into the infeed section of the catch of the latch.

3. The motor vehicle door latch according to claim 2, wherein the switch identification light is designed as a high-performance LED.

4. The motor vehicle door latch according to claim 1, wherein a light sensor is generally assigned to the switch identification light or the latch and is connected to the switch identification light by means of a circuit.

5. The motor vehicle door latch according to claim 1, wherein the activation button, in or on which the light diodes are distributed, has an attachable cover consisting of translucent material.

6. The motor vehicle door latch according to claim 5, wherein the light diodes are arranged in a circular shape around the switching component on the activation button.

7. The motor vehicle door latch according to claim 2, wherein the activation button of the child safety is embedded into the wall of the infeed section.

8. The motor vehicle door latch according to claim 1, wherein the light diodes are arranged to form a green-colored circle and a red-colored second circle and are addressed separately from a supply perspective.

9. The motor vehicle door latch according to claim 1, wherein the light diodes are designed to be switched to white light.

10. The motor vehicle door latch according to claim 1, wherein the switch identification light is designed as a self-illuminating element or an extraneous light-reflecting element.

11. The motor vehicle door latch according to claim 1, wherein the switch identification light is designed to cover the free section of a child safety lever.

12. The motor vehicle door latch according to claim 1, wherein the switch identification light is connected to a display on the driver's door, the dashboard and/or the rear motor vehicle door from a circuitry and a lighting perspective.
